(19) United States
(12) Patent Application Publication
(10) Pub. No.: US 2012/0065749 A1
(43) Pub. Date: Mar. 15, 2012

(54) Display of Devices on an Interface based on a Contextual Event

(75) Inventor: Jim Hunter, Sunnyvale, CA (US)

(73) Assignee: Motorola Mobility, Inc., Libertyville, IL (US)

(21) Appl. No.: 13/228,103

(22) Filed: Sep. 8, 2011

Related U.S. Application Data
(60) Provisional application No. 61/382,078, filed on Sep. 13, 2010.

(51) Int. Cl. G05B 15/00

(52) U.S. Cl. 700/83

(57) ABSTRACT

In one embodiment, a method includes receiving a signal indicating a detection of a detected event at an origination device. The signal is automatically received based on the detection by the origination device. A rule associated with the event is determined where the rule defines contextual information to determine for the event. The contextual information defined by the rule is then determined. The method then analyzes a context for devices in a set of devices to determine a group of devices in the set of devices based on the contextual information. Each device in the set of devices is classified with a context. The group of devices is sent to a destination device for automatic display of the group of devices to allow control of the group of devices from the destination device.

### CROSS REFERENCE TO RELATED APPLICATIONS

The present application claims priority to U.S. Provisional App. No. 61/382,078 for “Multiple Devices Displayed Upon Event” filed Sep. 13, 2010, the contents of which is incorporated herein by reference in their entirety.

### BACKGROUND

Particular embodiments generally relate to device control.

A user may control different devices using a user interface. For example, televisions, lights, thermostats, and other electronic devices may be controlled in a household. When a user wants to display devices on the user interface, the user submits a query for the devices to have them displayed. For example, the user may select devices serially and can then control the devices when they are displayed. For example, at different times (such as when the user thinks someone is at a front door), a user may want to check a video feed for the front door. In this case, the user would log on to a website that allows the user to view and control devices. The user would select a camera and is shown a video feed from the camera. The user can then control the camera or observe the video feed. After checking the video feed, the user may want to perform another action, such as turning on a hallway light. The user may then want to control a hallway light near the front door. The user then selects the hallway light and an interface is displayed to allow the hallway light to be controlled. It may be inconvenient for a user to manually select the camera and hallway light serially each time the user wants to view the video feed and control the hallway light.

### SUMMARY

In one embodiment, a method includes receiving a signal indicating a detection of a detected event at an origination device. The signal is automatically received based on the detection by the origination device. A rule associated with the event is determined where the rule defines contextual information to determine for the event. The contextual information defined by the rule is then determined The method then analyzes a context for devices in a set of devices to determine a group of devices in the set of devices based on the contextual information. Each device in the set of devices is classified with a context. The group of devices is sent to a destination device for automatic display of the group of devices to allow control of the group of devices from the destination device.

In one embodiment, a method includes receiving, at a first device, information for a group of devices associated with a detection of an event at a second device. The group of devices is determined based on contextual information associated with the event. The method then displays the information for the group of devices and displays a control for a controllable feature associated with a device in the group of devices. A command for the control is received to perform an action with the controllable feature and the command is sent to have the action performed to control the controllable feature for the device in the group of devices. The display of the information for the group of devices is automatically performed upon detection of the event at the second device.

In one embodiment, a non-transitory computer-readable storage medium contains instructions for controlling a computer system to be operable to: receive a signal indicating a detection of a detected event at an origination device, the signal being automatically received based on the detected event being detected by the origination device; determine a rule associated with the event, the rule defining contextual information to determine for the event; determine the contextual information defined by the rule; analyze a context for devices in a set of devices to determine a group of devices in the set of devices based on the contextual information, wherein each device in the set of devices is classified with a context; and send the group of devices to a destination device for automatic display of the group of devices to allow control of the group of devices from the destination device.

The following detailed description and accompanying drawings provide a more detailed understanding of the nature and advantages of the present invention.

### BRIEF DESCRIPTION OF THE DRAWINGS

FIG. 1 depicts a system for detecting an event and controlling devices automatically according to one embodiment.

FIG. 2 depicts a simplified flowchart of a method for configuring the display of devices according to one embodiment.

FIG. 3 depicts a simplified flowchart of a method for processing the detection of an event according to one embodiment.

FIG. 4 depicts a simplified flowchart of a method for displaying the group of devices according to one embodiment.

FIG. 5 depicts a more detailed example of a control point according to one embodiment.

FIG. 6 depicts a simplified system according to one embodiment.

### DETAILED DESCRIPTION

Described herein are techniques for a device control interface. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

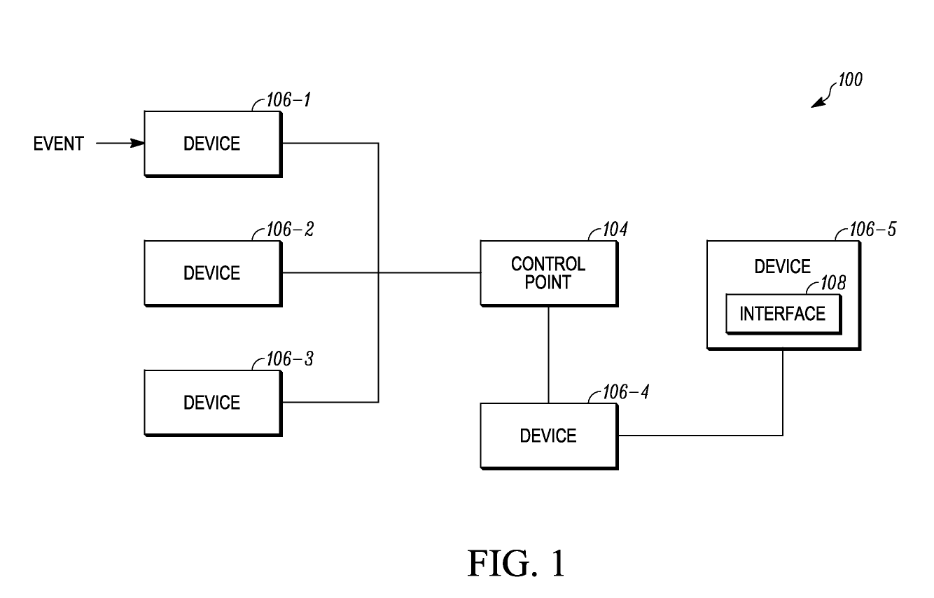

FIG. 1 depicts a system 100 for detecting an event and triggering a display of devices 106 according to one embodiment. System 100 includes devices 106 that may be items found in a location, such as a home, business, or other area. Devices 106 include physical devices, such as lights, televisions, appliances, and thermostats, and virtual devices, such as applications, content, music, and content feeds. For example, a device 106-1 is a “door lock”; a device 106-2 is a “global positioning service (GPS) sensor”; a device 106-3 is a “camera”; a device 106-4 is a “set top box”; and a device 106-5 is a “television (TV)”. Other devices 106 may also be appreciated.

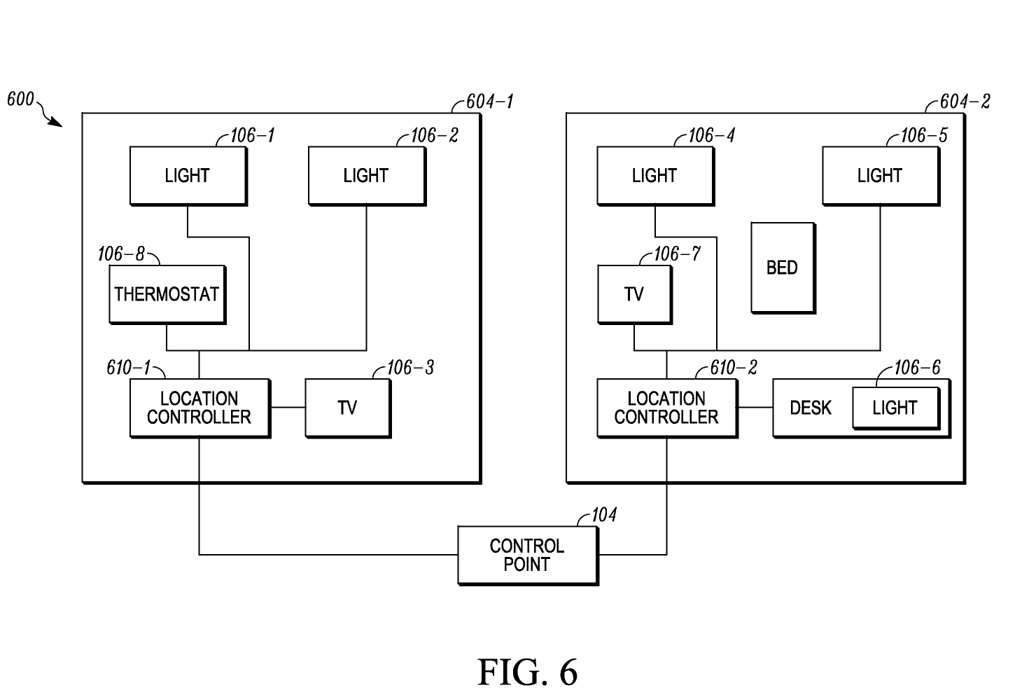

Devices 106 may be controlled via a control point 104. Control point 104 may cause actions to be performed with devices 106. For example, controllable features of devices 106 may be controlled, such as by turning devices 106 on or off via control point 104. In one embodiment, control point 104 may communicate through a network (shown in FIG. 6) to other location controllers (shown in FIG. 6) to cause the actions to be performed.

A user may control the controllable features of devices 106 through a user interface 108. For example, a device 106 may be displayed on user interface 108 and the user may select a control to have an action performed at device 106. When the term “device” is used, device may mean an icon, name, or other display notation that is used to represent a physical or virtual device that can be controlled. Each device 106 may display different information.

Particular embodiments provide the automatic display of devices 106 on user interface 108 upon detection of an event. A context for the event is determined and the context is used to select a group of devices 106. Thus, a user does not have to manually select devices 106 or query for devices 106 to have them displayed when the event occurs. Rather, devices 106 are automatically displayed on user interface 108 for a user to either view or control. The event may be associated with a controllable feature of device 106. For example, an unlock/lock controllable feature is associated with a door lock. The event may be defined as an unlocking of the door lock. In other embodiments, the event may be unrelated to a controllable feature. The context of the event provides a meaning to the event. For example, a user that unlocked the door may be determined to apply the context that the event. In this case, a group of devices 106 that are associated with the user may be selected for display.

When an event occurs at a device 106, device 106 sends a signal to control point 104, which can then correlate the event to a group of devices 106 that should be displayed when the event occurs based on the context. The context may be determined based on information associated with the event or information separate from the event. For example, the detection of the event may include detection of information for the context, such as the door may be unlocked with a smart card that includes an identifier for the user. Thus, it can be determined the user unlocked the door. Also, the GPS sensor (such as a GPS sensor in a cellular phone) may be used to determine the user is in the location of the door lock. Another context may be the location determined by the GPS sensor or the location of the door lock.

The contextual event is then used to determine the group of devices 106. For example, devices 106 may be tagged with metatags, which may be used to classify items. A metatag may be any information that describes the classification. For example, metatags may be included for uses, locations, connections, users, etc. The metatags may then be used to control items 108 using rules. The rules may specify triggers that perform an action when a condition is satisfied. For example, a rule may specify that items with the metatag “<user name>” and “<location>” be selected as a group of devices 106 when a contextual event occurs identifying the user is in the location.

In one example, one group of devices 106 is all devices 106 in the room associated with the location of the user that are tagged as being associated with the user. For example, the user may have a camera, hallway light, and television channels tagged as being associated with the user. The group of devices 106 are displayed on interface 108 when the contextual event of the user has unlocked the door lock is determined. In this case, control point 104 may send the group of devices 106 to the set top box for display on the television. The status and controls for the group of devices 106 may be displayed on user interface 108. The user may then view devices 106 that the user is interested in when in the room the user just entered.

Devices 106 may be displayed on user interface 108 in different display formats. For example, a scrolling collection may be used to display devices 106. Using the scrolling collection may simplify user interface 108 as only one device 106 may be displayed at a time. The display of devices 106 may scroll to allow a user to view all of the devices over a period of time. Other display formats may also be used where all of or a portion of devices 106 may be displayed at once in user interface 108. A user can associate different display formats with different events.

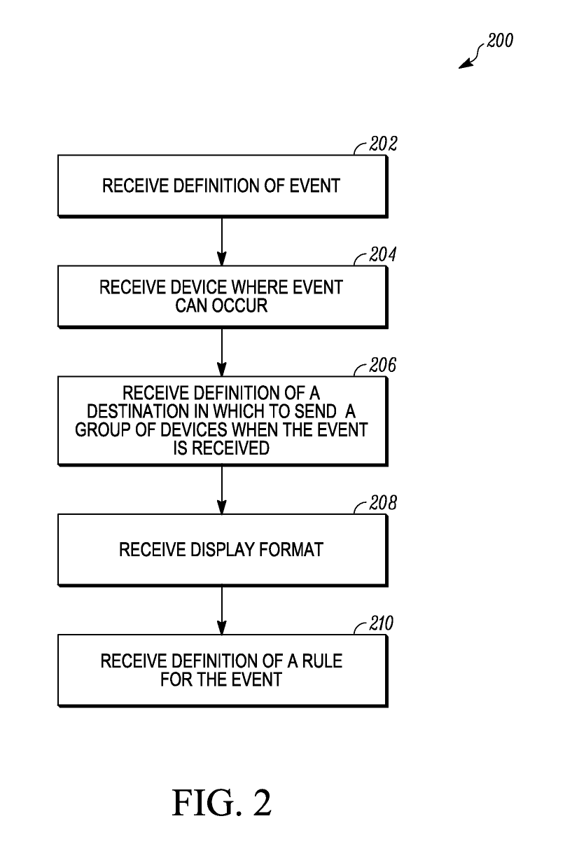

A user may configure the contextual event that may cause the display of devices 106. FIG. 2 depicts a simplified flowchart 200 of a method for configuring the display of devices 106 according to one embodiment. At 202, a definition of the event is received. For example, an event type may be defined. In one example, the event types are associated with controllable features of devices 106. For example, a door lock may be associated with a lock/unlock event type. Also, a light may be associated with a turn on and turn off event type.

At 204, a device 106 where the event should be detected is received. For example, a user may designate which device 106 should detect the occurrence of the event. The designation may be a specific device 106 or a type of device 106. For example, an identifier for the door lock may be used. Also, a designation may be all of the “lights” in a location.

At 206, a destination is defined in which to send a group of devices 106 when the event is received. For example, the user can define a device 106 in which to send a determined group of devices 106 for display. In other embodiments, system 100 may detect which device 106 a user is actively using and display the group of devices 106 on that device 106. For example, if a user is watching television, the group of devices 106 may be displayed on the television. Alternatively, if the user is using his/her computer, then the group of devices 106 may be displayed on the computer.

At 208, a display format is received. The display format defines how to display the determined group of devices 106, such as in a slide show format. In other embodiments, the user may not specify a display format. Rather, a standard or default display format may be used if a display format is not used.

At 210, a rule is defined for the event. The context may be used to determine the group of devices 106. In other embodiments, a specific group of devices may be defined for a specific event. In one example, the rule may include the context for event. Different metatags may have been associated with devices 106. For example, location metatags and user metatags may be defined for devices 106. The metatags classify devices 106. The rule would define the metatags for the event to provide context. For example, the rule may state that a user identifier and location should be determined as contextual information for the event. The user identifier and location are then used to determine devices 106 with metatags associated with the user identifier and location. Also, an action may be associated with the rule of display the group of devices 106 associated with the defined metatags at the defined destination device 106 in the defined display format.

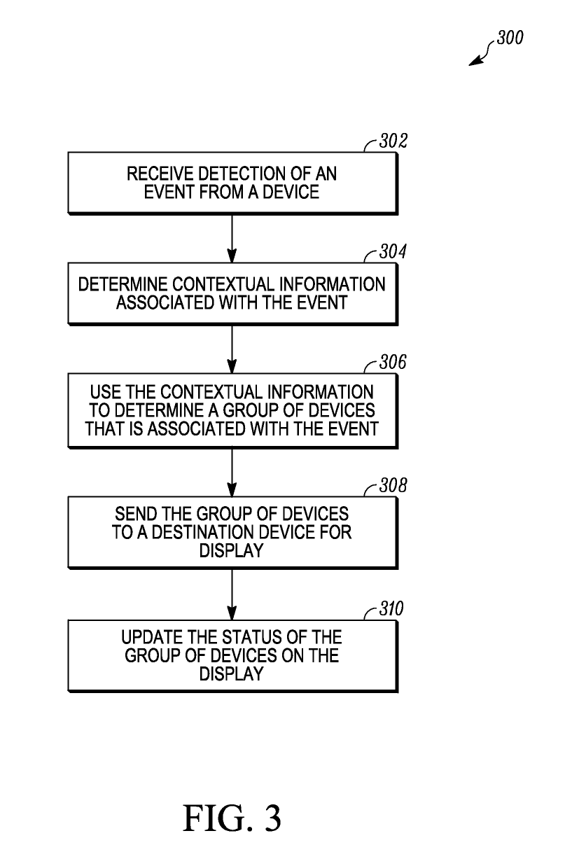

Once the configuration of the events and context has been completed, then the detection and processing of the event may be performed. FIG. 3 depicts a simplified flowchart 300 of a method for processing the detection of an event according to one embodiment. At 302, control point 104 receives a signal indicating an event has been detected at a device 106-1. In one example, device 106-1 may detect the event and send a signal to control point 104 indicating the event has occurred. Although control point 104 is described as receiving the detection of the event, it will be understood that other entities may perform the processing of the event. For example, other devices 106 may be used to process the event.

At 304, control point 104 determines contextual information associated with the event. For example, the rule associated with the event may define which contextual information to determine In one example, a location and identification of the user that performed the event is defined. The contextual information may have been detected by the device 106 that detected the event. Also the contextual information may be determined separately. For example, a location of device 106 where the event was detected is determined, such as through a location metatag associated with that device 106. Also, other contextual information identifying the user that caused the event may be determined This information may be determined through information detected by a separate device 106.

At 306, control point 104 uses the contextual information to determine a group of devices 106 that is associated with the event. For example, devices 106 that have metatags with the location and user identifier of the user are determined In this case, devices 106 tagged as being associated with the user in the location detected for the user may be grouped together.

At 308, control point 104 sends the group of devices 106 to a destination device 106 for display. For example, the rule may have specified which destination device 106 should be used to display the group of devices 106. In other embodiments, a device 106 that the user may be actively using or in a location where the user is detected to be present may be determined The group of devices 106 may also be sent with configuration information, such as information for which display format to use.

At 310, control point 104 updates the status of the group of devices 106 on the display. For example, control point 104 may set up streaming status updates for the group of devices 106. In this case, when status updates are received at control point 104, they are streamed to destination device 106. For example, the video feed from the camera may be set up to be streamed to user interface 108.

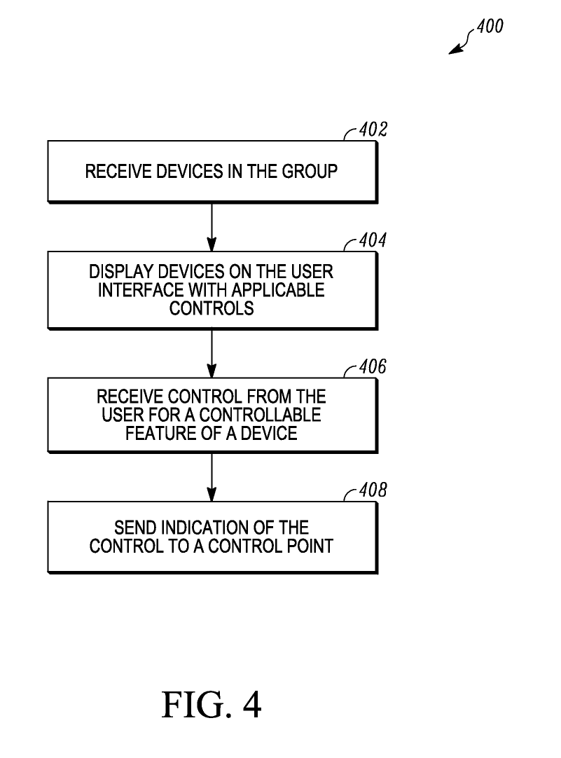

FIG. 4 depicts a simplified flowchart 400 of a method for displaying the group of devices 106 according to one embodiment. The method will be described with respect to device 106-4, but another device 106 may be used to display the group of devices 106. At 402, device 106-4 receives the group of devices 106. At 404, device 106-4 determines a display format associated with the group of devices 106. For example, a user may have indicated a scrolling collection should be used to display the group of devices 106. Device 106-4 then generates the scrolling collection.

At 406, device 106-4 displays the group of devices 106 on user interface 108 in the display format. Applicable controls for the group of devices 106 and content or a status may be displayed. In one example, a video feed of the location is displayed in addition to a control to move the camera. A hallway light may be displayed with the current status (e.g., on or off) and also a control to turn the hallway light on or off. A door lock may be displayed with the current status of unlocked or locked and also have a control to lock or unlock the door lock.

At 408, user interface 108 receives a control for a controllable feature of a device 106. For example, as a device 106 is displayed on user interface 108, the user may view the status and decide to control device 106. At 410, user interface 108 sends an action for the control to control point 104. For example, set top box 106-4 may send the indication of the control to control point 104. In one example, control point 104 may then cause the hallway light the turn on or off

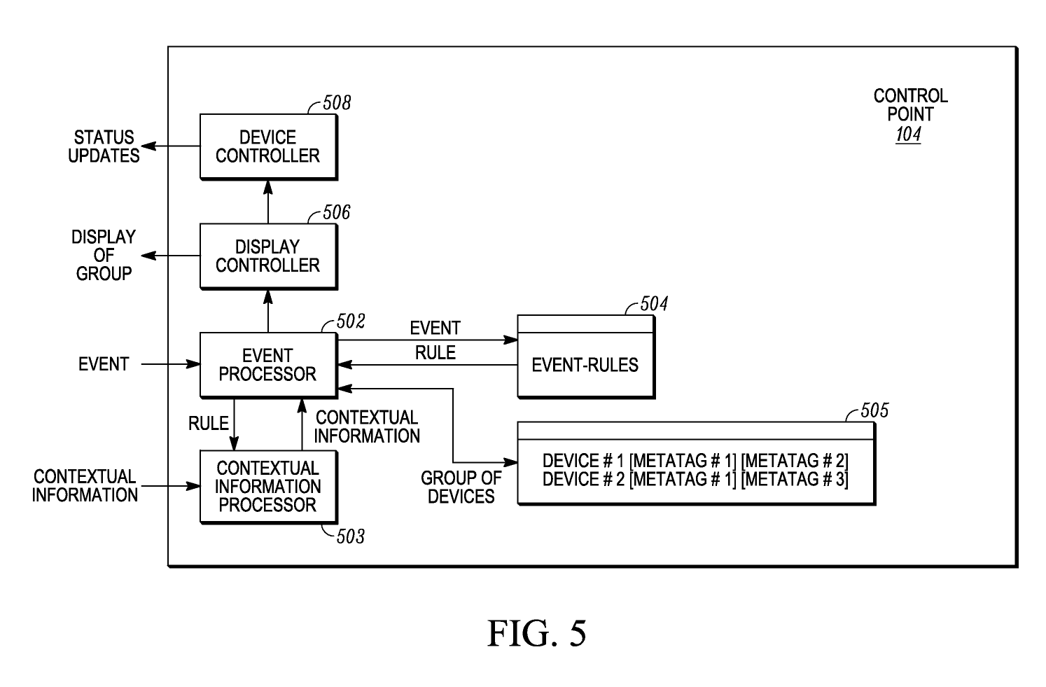

FIG. 5 depicts a more detailed example of control point 104 according to one embodiment. Different events and rules may be stored in memory 504. For example, an event #1 is associated with a rule #1; an event #2 is associated with a rule #2, and so on. As discussed above, the rules may define the contextual information to determine, detecting device 106, destination device 106, and/or display format.

An event processor 502 receives an indication of an event N. For example, a device 106 may detect an event and send it to control point 104. A rule in database 504 that is associated with the event is determined Then, event processor 502 queries a contextual information processor 503 to determine contextual information for the event based on the rule. Contextual information processor 503 may determine the contextual information from information received with the event, from device 106 that detected the event, or another device 106.

Once the contextual information is determined, event processor 502 determines the group of devices 106 from a database 505 based on the classification of devices 106. For example, metatags associated with devices 106 are used to determine the group of devices 106. Devices 106 may be independently classified with metatags and then based on the contextual information determined, the group of devices 106 is selected. This allows dynamic groups of devices 106 to be determined based on how devices 106 are classified. Also, in other embodiments, specific groups of devices 106 may be defined for an event. The devices 106 that are determined may be dissimilar based on context. For example, different users may be associated with different devices 106 in a location and different groups are determined for the different users. In one example, a device #1 is associated with metatags #1 and #2 and a device #2 is associated with metatags #1 and #3. Metatag #1 may be a user's name, metatag #2 may be “living room”, and metatag #3 may be “dining room”. If the contextual information is the user's name and living room, then device #1 is included in the group. If the contextual information is the user's name and dining room, then device #2 is included in the group.

Once the group of devices 106 is determined, a display controller 506 then sends the group of devices 106 with the display format to the destination device 106. The destination device 106 displays the group of devices 106 in the desired display format.

A device controller 508 may then set up the automatic updating of statuses for the group of devices 106. For example, status updates may be received from devices 106 at device controller 508. Device controller 508 may then determine which devices 106 need to be updated. Status updates for the group are then sent to the destination device 106-5. Thus, automatic updating of the status for the group of devices 106 is performed.

Accordingly, particular embodiments allow the automatic displaying of a group of devices 106 when an event occurs. Context is added to the event to determine the group of devices 106. The user does not have to query for the devices manually. Thus, when an event occurs, a user may conveniently be provided with a display of devices 106 that the user can either view the status of or control. The format of the display may also be simplified to allow the user to easily view the status of the group of devices 106 and also control the group of devices 106.

In one example, a user may enter a hotel room of a hotel by unlocking a door. The event is detected and contextual information for the event is defined as a location and identification of the user. The key used may include identification information for the user. The location may be determined based on the location of the door lock or by a location of a cellular phone of the user. Then, a group of devices 106 classified by the user identifier and location may be selected. For example, the group of devices 106 may be classified as devices associated with the user when the user is located outside of the user's home. The group of devices 106 may include devices 106 in the user's home that the user may want to monitor while away. For example, a video feed of the house, a thermostat, and status of lights in the house are displayed on a hotel room television.

FIG. 6 depicts a simplified system 600 according to one embodiment. As shown, control point 104 and locations 604 are provided. Locations 604 also include devices 106, and location controller 610.

Control point 104 is configured to control items 108 in locations 604. A location may be any area, such as a room, hallway, etc. System 600 may be broken up into locations 604. For example, the locations may be found in a house, business, or any other area. Although specific locations 604 are described, it will be understood that any number of locations may be controlled using control point 104.

Control point 104 causes actions to be performed with devices 106 based on contextual events detected. For example, devices 106 may be controlled by turning them off, turning them on, etc. via user interface 108. When a control is applied, user interface 108 may send a command to control point 104 to have the control applied to applicable devices 106. Control point 104 communicates with location controller 610 to have the control applied. In one embodiment, control point 104 may communicate through a network to location controllers 110. Location controllers 610 may then cause the actions to be performed with devices 106 that are in a specific location. For example, location controller 610-1 may be able to control devices 106-1-106-7.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
receiving a signal indicating a detection of a detected event at an origination device, the signal being automatically received based on the detection by the origination device;
determining a rule associated with the event, the rule defining contextual information to determine for the event;
determining the contextual information defined by the rule;
analyzing, by a computing device, a context for devices in a set of devices to determine a group of devices in the set of devices based on the contextual information, wherein each device in the set of devices is classified with a context; and
sending the group of devices to a destination device for automatic display of the group of devices to allow control of the group of devices from the destination device.

2. The method of claim 1, wherein determining the contextual information comprises determining the contextual information from the origination device that detected the detected event.

3. The method of claim 1, wherein determining the contextual information comprises determining the contextual information from a different device than the origination device that detected the detected event.

4. The method of claim 1, wherein analyzing the context comprises analyzing metatags classifying the set of devices to determine devices that include a metatag that is associated with the contextual information.

5. The method of claim 4, wherein the group of devices is determined dynamically based on the contextual information and the metatags.

6. The method of claim 1, wherein the information comprises a status or content for a device in the group of devices.

7. The method of claim 1, further comprising sending an update of a status or content for a device in the group of devices to the destination.

8. The method of claim 1, further comprising:
receiving an action to perform from the destination device for a device in the group of devices; and
causing the device to perform the action.

9. The method of claim 1, further comprising determining a location associated with the user, wherein the destination device is determined based on the location associated with the user.

10. The method of claim 1, wherein the rule associated with the configured event identifies where to send the information when the detected event occurs.

11. The method of claim 1, wherein the rule is associated with a display format, the method further comprising:
sending the display format to the destination device to cause the destination device to display the group of devices using the display format.

12. A method comprising:
receiving, at a first device, information for a group of devices associated with a detection of an event at a second device, the group of devices determined based on contextual information associated with the event;
displaying the information for the group of devices;
displaying a control for a controllable feature associated with a device in the group of devices;
receiving a command for the control to perform an action with the controllable feature; and
sending the command to have the action performed to control the controllable feature for the device in the group of devices,
wherein the display of the information for the group of devices is automatically performed upon detection of the event at the second device.

13. The method of claim 12, further comprising:
receiving a status update for a device in the group of devices; and
displaying the status update for the device in the group of devices.

14. The method of claim 12, further comprising:
receiving content for a device in the group of devices; and
displaying the content for the device in the group of devices.

15. The method of claim 12, further comprising:
receiving a display format for the group of devices; and
configuring the group of devices to be displayed in the display format.

16. A non-transitory computer-readable storage medium containing instructions for controlling a computer system to be operable to:
receive a signal indicating a detection of a detected event at an origination device, the signal being automatically received based on the detected event being detected by the origination device;
determine a rule associated with the event, the rule defining contextual information to determine for the event;
determine the contextual information defined by the rule;
analyze a context for devices in a set of devices to determine a group of devices in the set of devices based on the contextual information, wherein each device in the set of devices is classified with a context; and
send the group of devices to a destination device for automatic display of the group of devices to allow control of the group of devices from the destination device.

17. The non-transitory computer-readable storage medium of claim 16, wherein determine the contextual information comprises determine the contextual information from the origination device that detected the detected event.

18. The non-transitory computer-readable storage medium of claim 16, wherein determine the contextual information comprises determine the contextual information from a different device than the origination device that detected the detected event.

19. The non-transitory computer-readable storage medium of claim 16, wherein analyze the context comprises analyzing metatags classifying the set of devices to determine devices that include a metatag that is associated with the contextual information.

20. The non-transitory computer-readable storage medium of claim 16, wherein analyze the context comprises analyze metatags classifying the set of devices to determine devices that include a metatag that is associated with the contextual information.
